(19) United States
(12) Patent Application Publication
(10) Pub. No.: US 2005/0091682 A1
(43) Pub. Date: Apr. 28, 2005

(54) System and method for providing advertising after a video program has been paused

(76) Inventor: David Czeck, Beaverton, OR (US)

Correspondence Address: LAW OFFICE OF DEREK J. WESTBERG, 2 NORTH SECOND STREET, SUITE 1390, SAN JOSE, CA, 95113, US

(21) Appl. No.: 10/693,280

(22) Filed: Oct. 23, 2003

(51) Int. Cl. H04N 7/025; G06F 13/00; H04N 5/445; G06F 3/00; H04N 7/10; H04N 5/45

(52) U.S. Cl. 725/32; 725/42; 348/563; 348/565

(57) ABSTRACT

A system and method for inserting advertising into a video program after the video program is paused. When the video program is paused a still image from the video program is provided in its stead. An advertisement image is provided in addition to the still image.

### FIELD OF THE INVENTION

The present invention relates generally to video services and more particularly, to a system and method for providing advertisements in conjunction with video services.

### BACKGROUND OF THE INVENTION

In recent years, the media industry has expanded its horizons beyond traditional analog technologies. Video programs, including feature films are now being recorded and converted into digital formats. With this conversion to digital formats comes the ability of the media industry to provide enhanced video services to a viewer.

An example of an exhanced video service is Video-on-Demand (VOD) service. VOD is similar to a traditional video rental service except that the program is streamed to the viewer through a media delivery network such as a cable network. The VOD service might provide the viewer with the ability to perform trick functions on the audio-video stream. Examples of such trick functions are: pause, rewind, fast forward, slow play and slow rewind. Another example of enhanced video service is provided by a Personal Video Recorder (PVR). A PVR allows trick functions to be performed, similarly to that of VOD, except that program data is stored and manipulated locally to the viewer.

As an example of use of the pause function, the viewer may request a particular video stream from a video service. The service may respond by sending the stream to the viewer. The viewer may then request that the stream be paused. The the stream is then paused until the viewer makes an additional request.

### BRIEF SUMMARY OF THE INVENTION

The invention is a system and method for providing advertising after a video stream has been paused. In one embodiment of the invention, a media server (e.g., a VOD server) is connected to one or more client devices (e.g. a Set Top Box (STB)). A viewer may communicate with the VOD server through the STB. The viewer may request that the VOD server pause a video stream. The viewer may then be presented with a paused image of the video stream. After a configurable amount of time the paused image may be combined with an advertisement image. An indication of the stream having been paused may be combined with the advertising images. These and other aspects of the invention are described in more detail herein.

### BRIEF DESCRIPTION OF THE DRAWINGS

FIG. 1 is a flow chart of an exemplary method by which the present invention might be implemented;

FIGS. 2A-C are combined images produced in accordance with an embodiment of the invention;

FIGS. 3A-C are block diagrams of how data might flow between a VOD server and a STB in accordance with embodiments of the invention;

FIG. 3D is a block diagram of how data might flow in a Personal Video Recorder (PVR) in accordance with an embodiment of the invention; and

FIGS. 4A-D are block diagrams of how data might flow to and from a combiner in accordance with embodiments of the invention.

### DETAILED DESCRIPTION OF THE INVENTION

The present invention is a system and method for providing advertising after a video program has been paused. As used herein, the term “video program” includes video content being streamed from a remote location while it is being viewed and video content that is stored at the location of viewing and may also include accompanying audio. Also, the video program may be “paused” by any trick function that results in display of a still image. Examples of such trick functions include: pause, slow play, slow rewind, individual frame selection and frame by frame forward or reverse advance. The present invention is described herein in connection with VOD and PVR services and related devices. However, it will be apparent that the present invention may be used in connection with any video service in which a video program may be paused.

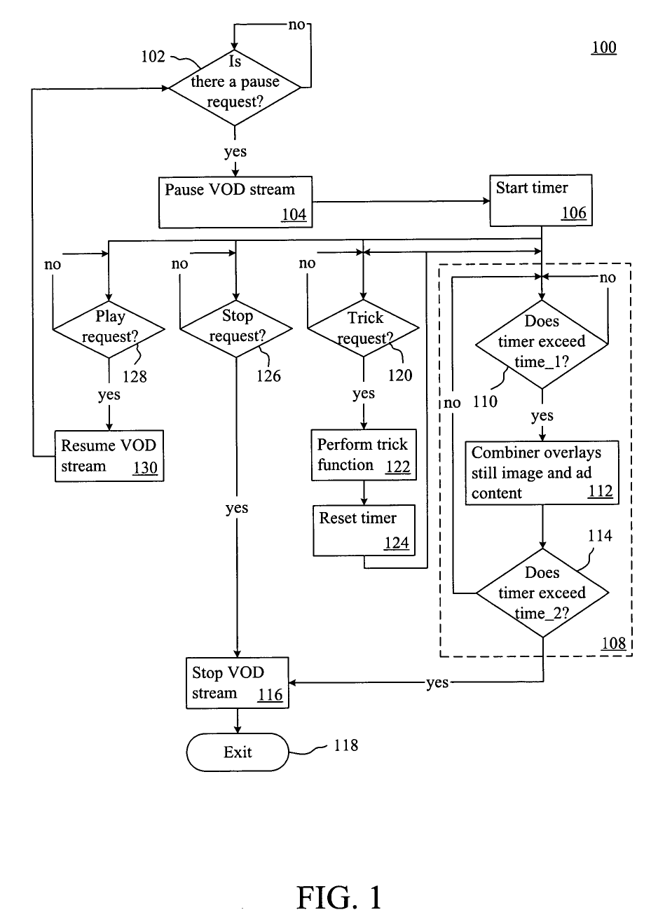

Flow-chart 100 in FIG. 1 is a diagram of a method by which the present invention might be implemented. A viewer may be viewing a particular audio video stream. The stream may be a pre-recorded broadcast or a live broadcast that is being cached in the event that the viewer requests a trick function be preformed on the stream. At some time during the broadcast, the viewer may request that the stream be paused in step 102. A still image may then be presented to the viewer in step 104. After the still image is presented, a timer may be started in step 106. Logical loop 108 includes steps 110, 112 and 114. Once the timer exceeds a first configurable time (time_1) as determined in step 110, then an advertisement may be added to the still image in step 112. This configurable amount of time may be zero or greater. If set to substantially zero, the advertising image may be provided instantaneously after the program is paused. Otherwise, the system waits for the time (e.g., 10 or 30 seconds) to elapse before providing the advertisement. Once the timer exceeds a second configurable time (time_2) as determined in step 114, then the stream may be stopped as in step 116. The time_2 is set to be large enough such that if the timer exceeds time_2 then it is safe to assume that the viewer has probably stopped watching the stream. Stopping the stream in step 116 may include reassigning resources that were being used to provide the stream to the viewer. Examples of resources that might be reassigned are transmission bandwidth, processing power and/or memory. The resources may be reassigned to provide video services, to other viewers. Also in step 116 the image presented to the viewer may be changed to a default image, presenting the viewer with additional viewing options, or it may return to a live video stream or display no image at all. Step 118 is an exit point for this method, the method may start again at step 102 if viewer makes a pause request.

Thus, the advertising image is provided to the viewer in response to the viewer's request to pause the video program. The viewer is passive with respect to the advertising content in that the viewer does not actively request display of the advertising content. Rather, pausing the video program provides an opportunity (e.g., by freeing up processing capability and/or communication bandwidth) to present the advertising content without interfering with normal viewing of the video program (i.e. when the program is not paused).

After the stream has been paused in step 104 and the timer has been started in step 106, repeated checks may be made as to whether the viewer has any further requests. For this purpose, steps 120, 126 and 128 may repeatedly check if the viewer has made any requests, an algorithm using interrupts may be used for this purpose. Steps 120, 126 and 128 may be performed at the same time as loop 108. If the viewer does make a request as determined by either step 120, 126 or 128 then loop 108 may be stopped. For example, step 120 may determine that the viewer has requested that a trick function be performed on the stream. During step 122 the trick function may be performed, after which a new still image may be presented to the viewer. Next in step 124 the timer set in step 108 may be reset to zero and the logical loop 108 may be restarted from step 110. In addition, step 120 may once determine if a trick request has been made.

If the viewer requests that the stream be stopped as determined in step 126, then loop 108 may be stopped and program flow may move to step 116. Step 116 having been previously described.

If the viewer requests that the stream resume playing as determined in step 128, then loop 108 may be stopped. Then in step 130, any advertisements that had previously been inserted into the still image may be removed from the still image and the stream may be continued from where it had previously been paused in step 104 or a new position in the stream if a trick function had previously been performed in step 122. The next step after step 130 is to wait until the viewer makes an additional pause request (step 102).

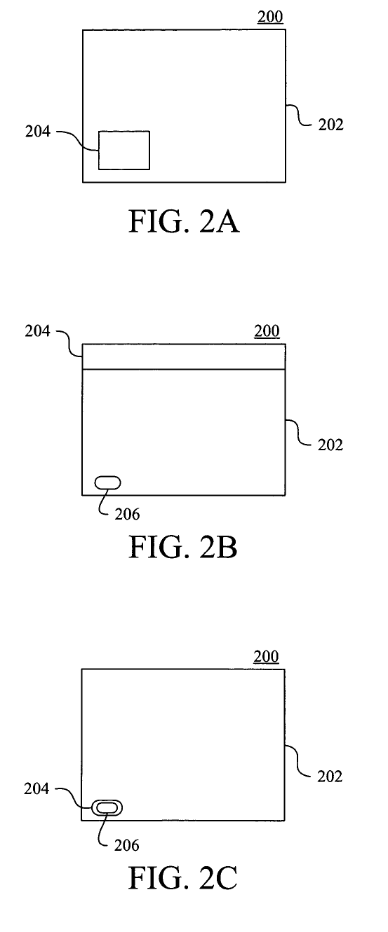

FIGS. 2A-C are examples of images that might be provided to the viewer once they have made a pause request. During step 104 and/or step 122 of FIG. 1 a still image 202 is provided to the viewer. The still image 202 may be the last frame presented to the viewer before they made the pause request (step 102) or it may be some other related image.

FIG. 2A is an exemplary combined image 200, which might be produced in accordance with a first embodiment of the invention, as in step 112 of FIG. 1. An advertisement image 204 may be combined with the still image 202. For example, the advertisement image 204 may be superimposed over some portion of the still image 202. The advertisement image 204 may be inset from the edges of the still image 202. The advertisement image 204 may have the same aspect ratio as the still image 202.

The advertisement image 204 may include: a single image; a set of images; a series of images; or a video stream (with or without accompanying audio). A series of advertisement images 204 may be presented to the viewer. Billing information may be recorded after each advertisement image 204 is presented to the viewer. A provider of VOD services may wish to keep a complete or limited record of what advertisements are presented to the viewer. The record may contain: viewer identity; the identity of the advertisement image 200; the content of the stream; the time at which the advertisement image 204 was presented; and/or the duration for which the advertisement image 204 was presented. The provider may choose only to record some of the items listed above to insure the privacy of the viewers. The content of the advertisement image 204 may be selected to take into account the identity of the viewer and/or the content of the stream. A different advertisement image 204 may be presented to the viewer after each pause request. If the advertisement image 204 is a video advertisement stream then the stream may be allowed to finish before it is removed from the combined image 200 in step 130 of FIG. 1.

FIG. 2B is an alternate exemplary combined image 200, which might be produced in accordance with a second embodiment of the invention, as in step 112 of FIG. 1. As in FIG. 2A, the advertisement image 204 may be superimposed over the still image 202 to produce the combined image 200. FIG. 2B shows that the advertisement image 204 may be a banner image superimposed across the top or bottom of the still image 202. For example, the still image 202 may be a letterbox image that includes blank top and bottom borders, in which the advertisement image may be placed. Further, the size of the still image 202 may be altered such that the advertisement image 204 does not cover the still image 202. The combined image 200 may also include an additional image 206. One example of the additional image 206 might be a solid or translucent pause indicator 206 to indicate to the viewer that the content stream is currently paused. The additional image 206 may also be used to communicate other information that might be of interest to the viewer.

FIG. 2C is another alternate exemplary combined image 200, produced in accordance with a third embodiment of the invention, and which might be used in place of the still image 202 in step 104 of FIG. 1 or the combined image 200 in step 112 of FIG. 1. The additional image 206 and the advertisement image 204 might be combined with each other, and superimposed on the still image 202 to produce the combined image 200. An example of such a combination might be a pause button that includes advertisement content such as a slogan and or some other graphical image.

In yet another alternate embodiment of the invention, in step 112 of FIG. 1, the advertisement image 204 may replace the still image 202. The additional image 206 may be combined with the advertisement image 204 to indicate that the content stream is paused and/or that the advertisement image 204 is indeed an advertisement.

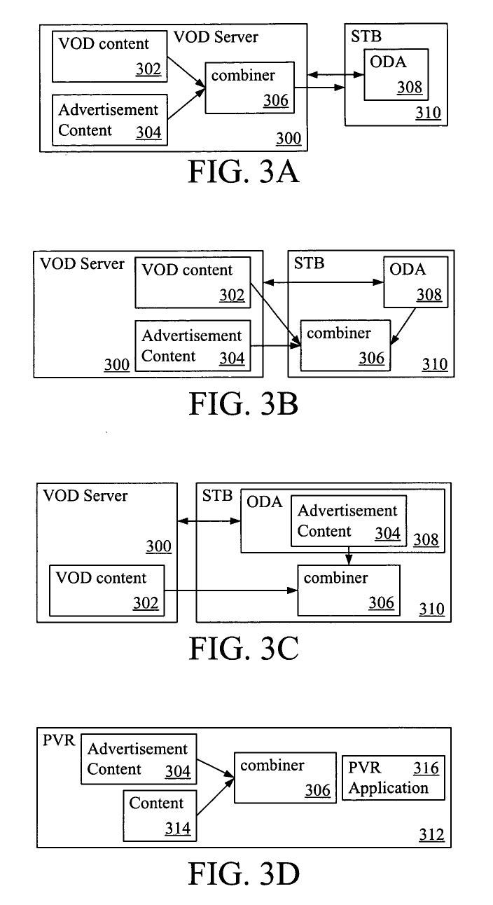

FIG. 3A is a block diagram of a first exemplary system in accordance with an embodiment of the present invention, which includes a VOD server 300 and one or more STBs 310. The VOD server 300 may be any combination of hardware and/or software that provides audio-video content to the viewer. The STB 310 may also be any combination of hardware and/or software that provides the viewer with an interface to the VOD server 300, thus, allowing the viewer to request a particular stream. The viewer may also request that particular trick functions be performed on the stream.

The connection between the STB 110 and the VOD server 300 may be a dedicated cable network, a public network such as the Internet, a wireless network such as satellite, radio or optical, or a direct, dedicated connection. The audio-video content may be provided to the viewer as: an analog stream; a digital stream; a data file or any other format the STB 310 can understand. The VOD server 300 may provide a single stream that is a multiplex of individually addressed content, wherein each viewer only sees the content to which it has been addressed.

The viewer's requests to the VOD server 300 may be made through an On-Demand Application (ODA) 308 that resides on the STB 310. When the viewer wants the particular stream to be delivered to the STB 310 they will use the ODA 308 to submit the request.

The stream may be located in a first storage area on the VOD server 300. The first storage area may be one or more hard drives set up in a RAID configuration, or some other storage system. The storage system is not dependent on the storage medium such as: optical, solid-state, magnetic, or magneto-optical storage medium. The first storage area may contain VOD content 302 for one or more streams. The VOD server 300 may send the stream directly from the storage area 302 to the STB 310. Alternatively, the VOD server 300 may alter the stream before the VOD server 300 sends the stream to the STB 310.

A combiner 306 may be used to combine an advertisement with the stream. The combiner 306 may be hardware, software or a combination of both. The advertisement may be located in a second storage area. The second storage area may contain advertisement content 304 for one or more advertisements.

FIG. 3B is a block diagram of a second exemplary system in accordance with an embodiment of the present invention, which includes the VOD server 300 and one or more STBs 310. As in FIG. 3A the VOD content 302 and advertisement content 304 may be located on the VOD server 300. In addition, the ODA 308 is located on the STB 310. The combiner 306 may also be located on the STB 310. The combiner 306 may be a part of the ODA 308 or the ODA 308 may communicate directly with the combiner 306, providing the combiner with instructions. Locating the combiner 306 on the STB 310 may reduce the bandwidth load on the connection between the VOD server 306 and the STB 310, by reducing the amount of information that is sent to the STB 310 during a pause function. Also, it may allow for a quicker display of the combined image 202 if the configurable amount of time is substantially zero. This is because the still image 202 and/or the additional image may be located at the on the STB 310 and need not be sent to the STB 310 during a pause function.

FIG. 3C is a block diagram of a third exemplary system in accordance with an embodiment of the present invention, which includes the VOD server 300 and one or more STBs 310. As in FIG. 3B the VOD content is located on the VOD server 300. In addition, the combiner 306 and the ODA 308 is located on the STB 310. The advertisement content 304 may be incorporated into the ODA 308. A remote server such as the VOD server 300 may update the advertisement content 304 on a regular basis. Locating the advertisement content 304 on the STB 310 may further reduce the bandwidth load on the connection between the VOD server 306 and the STB 310.

FIG. 3D is a block diagram of a fourth exemplary system in accordance with an embodiment of the present invention, which may comprise a Personal Video Recorder (PVR) 312. The PVR is an apparatus that provides a viewer with some of the advantages of a VOD system but is at the viewer's location. Content 314 may be located on the PVR 312. The content 314 may be one or more audio-video streams that the PVR may have recorded from a digital and/or analog audio-video stream, or from some other external source.

The advertisement content 304 may also be located on the PVR 312. A remote server may update the advertisement content 304 on a regular basis. The combiner 306 may be located on the PVR 312. Similar in action to the combiner 312 described above, combiner 306 may combine the content 314 with the advertisement content 304.

A PVR application 316 may be located on the PVR 312. The PVR application 316 provides an interface between the viewer and the PVR 312. The PVR application 316 may be separated from the other elements of the PVR 312, or the some or all of the elements may be substantially incorporated into the PVR application 316. There may be a connection between the PVR 312 and a remote server, which occurs on a regular basis. This connection may be used to update information about the activities of the viewer, update the components of the PVR 312 and/or alter the advertisement content 304.

A fifth exemplary system in accordance with an embodiment of the present invention may comprise a Network Personal Video Recorder (NPVR) rather than a PVR. The NPVR is an apparatus that provides a viewer with some of the advantages of the PVR 312 but the content 314 and/or the advertisement content 304 is at a remote location. Each viewer may select which content is stored for that viewer. Thus, the NPVR has essentially the same functionality as the PVR 312.

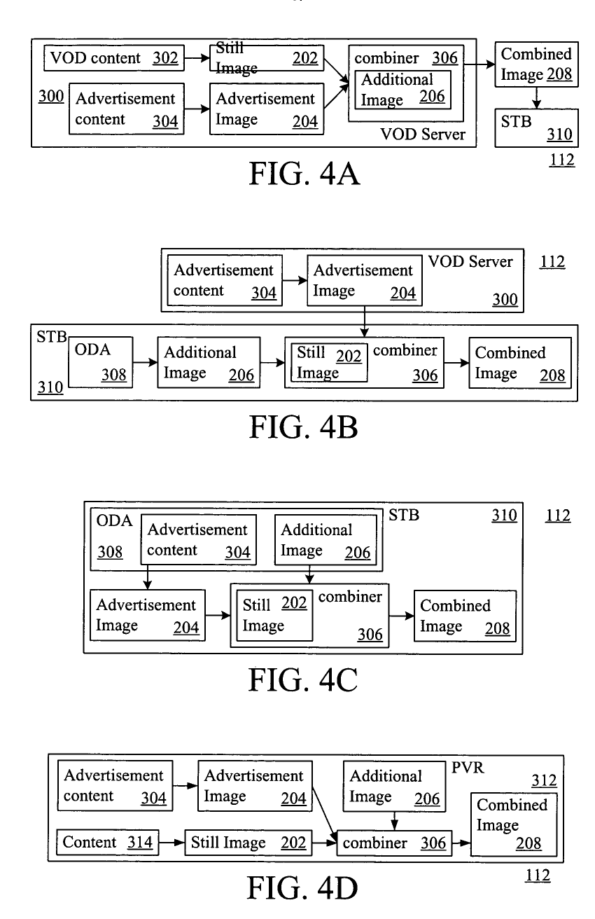

FIG. 4A is a first exemplary block diagram that shows how data might flow in and out of the combiner 306 to produce the combined image 200 during step 112 of FIG. 1. The still image 202 may be produced from information in the VOD content 302 located on the VOD server 300. The advertisement image 204 in FIGS. 2A-C may be produced from information in the advertisement content 304 located on the VOD server 300. The additional image 206 may be incorporated into the combiner 306 or some other part of the VOD server 300. The combiner 306, located on the VOD server may combine the still image 202, the advertisement image 204 and/or the additional image 206 to produce a combined image 200 that is provided to the STB 310.

FIG. 4B is a second exemplary block diagram that shows how data might flow in and out of the combiner 306 to produce the combined image 200 during step 112 of FIG. 1. As in FIG. 4A the advertisement image 204 may be produced from information in the advertisement content 304 located on the VOD server 300. The VOD server 300 may provide the STB 310 with the advertisement image 204. The ODA 310 on the STB 310 may provide the additional image 206. The combiner 306 may be located on the STB 310. The combiner 306 or some other component on the STB 310 may have information about the video content of the stream. This information may be used to produce the still image 202. The combiner 306 may combine the still image 202, the advertisement image 204 and/or the additional image 206 to produce a combined image 200 that is provided to the viewer.

FIG. 4C is a third exemplary block diagram that shows how data might flow in and out of the combiner 306 to produce the combined image 200 during step 112 of FIG. 1. As in FIG. 4B the combiner 306, the ODA 308, the additional image 206, the still image 202 and the combined image 208 may be located on the STB 310. In addition, the advertisement content 304 may be incorporated into the ODA 308 or some other component of the STB 310. The combiner 306 may combine the still image 202, the advertisement image 204 and/or the additional image 206 to produce a combined image 200 that is provided to the viewer.

FIG. 4D is a fourth exemplary block diagram that shows how data might flow in and out of the combiner 306 on the PVR 312 to produce the combined image 200 during step 112 of FIG. 1. The PVR 312 may include the content 314 that may include audio-video content that is of interest to the viewer. The still image 202 may be produced from information in the content 314. The advertisement image 204 may be produced from information in the advertisement content 304 also located on the PVR 312. The additional image 206 may also be located on the PVR 312. The combiner 306, located on the PVR 312 may combine the still image 202, the advertisement image 204 and/or the additional image 206 to produce a combined image 208 that is provided to the viewer.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing form the spirit and scope of the invention.

1. A method for inserting advertising into a video program comprising: providing a still image from the video program when the video program has been paused; combining an advertisement image with the still image thereby forming the combined image; and providing the combined image.

2. The method of claim 1, further comprising waiting a first configurable amount of time after the video program has been paused to provide the combined image.

3. The method of claim 1, wherein the video program includes audio.

4. The method of claim 1, further comprising: performing a trick function on the video program; presenting a new still image from the video program after the trick function has been performed; waiting an additional configurable amount of time after the trick function has been performed; and presenting the combined image after the additional configurable amount of time has passed.

5. The method of claim 1, wherein the still image comprises an image from the video program and an additional image.

6. The method of claim 1, wherein the video program continues to play.

7. The method of claim 1, comprising the additional step of ceasing to provide the combined image.

8. The method of claim 7, wherein said ceasing is performed after a second configurable amount of time.

9. The method of claim 7, wherein the advertisement image is an advertisement video program and the advertisement video program finishes, before the said ceasing.

10. The method of claim 1, wherein a series of advertisement images are provided.

11. The method of claim 1, further comprising recording billing information after an advertisement image is provided.

12. A system for inserting advertising into a video program that comprises: a means for providing a still image from the video program when the video program has been paused; a means for combining an advertisement image with the still image; and a means for providing the combined image.

13. The system of claim 12, wherein the system waits a first configurable amount of time after the video program has been paused; and then provides the combined image.

14. The system of claim 12, wherein the video program includes audio.

15. The system of claim 12, that further comprises: a means for performing a trick function on the video program; a means for providing a new still image from the video program after the trick function has been performed; waits an additional configurable amount of time after the trick function has been performed; and a means for providing the combined image after the additional configurable amount of time has passed.

16. The system of claim 12, wherein the still image comprises an image from the video program and an additional image.

17. The system of claim 12, wherein the video program continues to play.

18. The system of claim 12, wherein the combined image ceases to be provided.

19. The system of claim 18, wherein the said ceasing is performed after a second configurable amount of time.

20. The system of claim 18, wherein the advertisement image is an advertisement video program and the advertisement video program finishes, before the video program is stopped.

21. The method of claim 12, wherein a series of advertisement images are provided.

22. The method of claim 12, further comprising a means for recording billing information after the advertisement image is provided.

23. A system comprising: a stream server for providing a video program; a combiner for combining a still image from the video program with an advertising image to produce a combined image; and a client device for providing the combined image to a viewer.

24. The system of claim 22, wherein the stream server comprises: the combiner; VOD content; and advertisement content which provides the combiner with the advertisement image.

25. The system of claim 22, wherein the client device comprises: the combiner and advertisement content that provides the combiner with the advertisement image.

26. The system of claim 22, wherein the client device comprises a combiner and the VOD server provides the advertisement image to the combiner.

27. A system comprising: video content for providing a video program; a combiner for combining a still image from the video program with an advertising image to produce a combined image; and a device for providing the combined image to a viewer.
